(19) United States
(12) Patent Application Publication
(10) Pub. No.: US 2024/0378656 A1
(43) Pub. Date: Nov. 14, 2024

(54) STREAMLINED IMAGE TO MESSAGE AND ACTION REPLACEMENT WORKFLOW WITH MULTI-MODALITY MACHINE-LEARNED LARGE LANGUAGE MODEL

(71) Applicant: Maplebear Inc., San Francisco, CA (US)

(72) Inventors: Ze He, Sunnyvale, CA (US); Dian Ding, Santa Clara, CA (US); Hechao Sun, Mountain View, CA (US)

(21) Appl. No.: 18/661,317

(22) Filed: May 10, 2024

Related U.S. Application Data
(60) Provisional application No. 63/465,804, filed on May 11, 2023.

(51) Int. Cl. G06Q 30/0601; G06V 10/774

(52) U.S. Cl. CPC G06Q 30/0631; G06Q 30/0633; G06Q 30/0639; G06V 10/774

(57) ABSTRACT

A computer system receives an image from a picker, which indicates an out-of-stock target item and potential replacements items. The system provides, to a machine learning model, a prompt requesting identification of the target item and the potential replacement items in the image. The system receives identification of the target item and a list of potential replacement items in the image. The system generates a first list of potential replacements items based on the list of potential replacement items identified in the image and a second list of replacement items from the target item by applying one or more replacement models to the identified target item. The system may merge the two lists and assign replacement scores to each item in the merged list to create a list of recommended replacement items. The system generates a message based on the image and the list of recommended replacement items.

### CROSS-REFERENCE TO RELATED APPLICATIONS

This application claims the benefit of U.S. Provisional Patent Application No. 63/465,804, filed on May 11, 2023, which is incorporated herein by reference in its entirety.

### BACKGROUND

An online system is an online platform that provides one or more online services. An example of an online service is allowing users to perform transactions associated with items. The items may represent physical entities stored in a physical location. A user can place an order for purchasing items from participating retailers via the online system, with the shopping being done by a picker. Often times communication between the picker and the user will often happen when some target items were not found by the picker and the user needs to make a decision to either pick a replacement or ask for a refund. Pickers typically need to initiate the process, explain the situation by typing a message (sometimes with an image), and ask for customer approval, which is a manual and time consuming process. Alternatively, pickers can also simply start a replacement proposal push to save time, but it may not be the best user experience to have a lack of visibility and options.

### SUMMARY

In accordance with one or more aspects of the disclosure, the techniques described herein relate to a method for a system providing replacement recommendations using images of out-of-stock items and surrounding items (e.g., an item adjacent to the out-of-stock item). The system receives an image from a picker. The image may indicate that a target item is not available, and the target item is part of an order by a customer. The image may also indicate one or more potential replacements items for the target item. The system provides, to a machine learning model, a prompt requesting identification of the target item and the one or more potential replacement items for the out-of-stock item in the image. The system receives, as a response, identification of the target item, and a list of potential replacement items in the image.

The system then generates a first list of potential replacements items based on the list of potential replacement items identified in the image and a second list of replacement items from the target item by applying one or more replacement models to the identified target item. The system may merge the first list and the second list of potential replacement items and assign replacement scores to each item in the merged list of potential replacement items to create a list of recommended replacement items. The system generates a message for the customer based on the image and the list of recommended replacement items and provides the message and a set of replacement item cards associated with the list of recommended replacement items to the picker for review and to push to the customer.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a system workflow diagram for identifying replacement items from an image including an out-of-stock item, in accordance with one or more embodiments.

FIG. 4 is an example process workflow diagram for identifying replacement items for a strawberry banana parfait out-of-stock item, in accordance with one or more embodiments.

FIG. 5 is a flowchart for determining target item replacements, in accordance with one or more embodiments.

FIG. 6 is an example of a user interface depicting a message for recommending replacement items for an out-of-stock target item, according to one or more embodiments.

### DETAILED DESCRIPTION

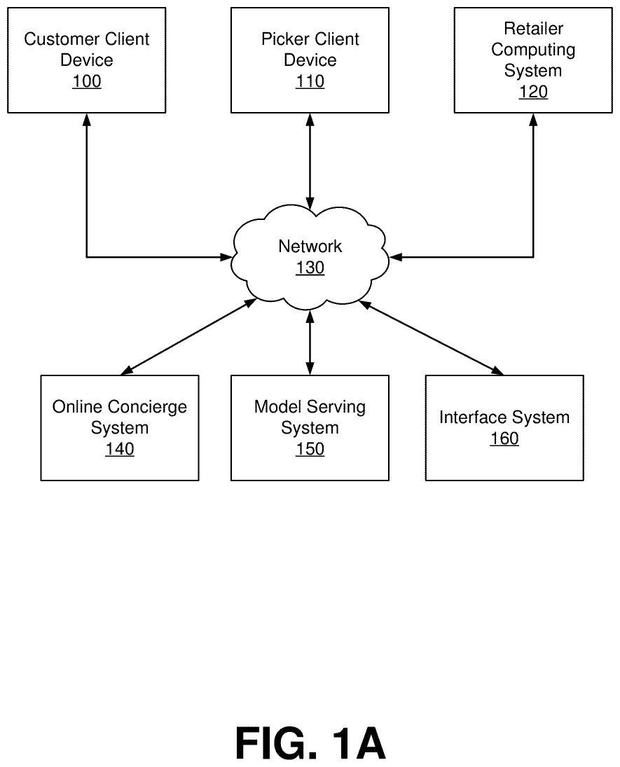

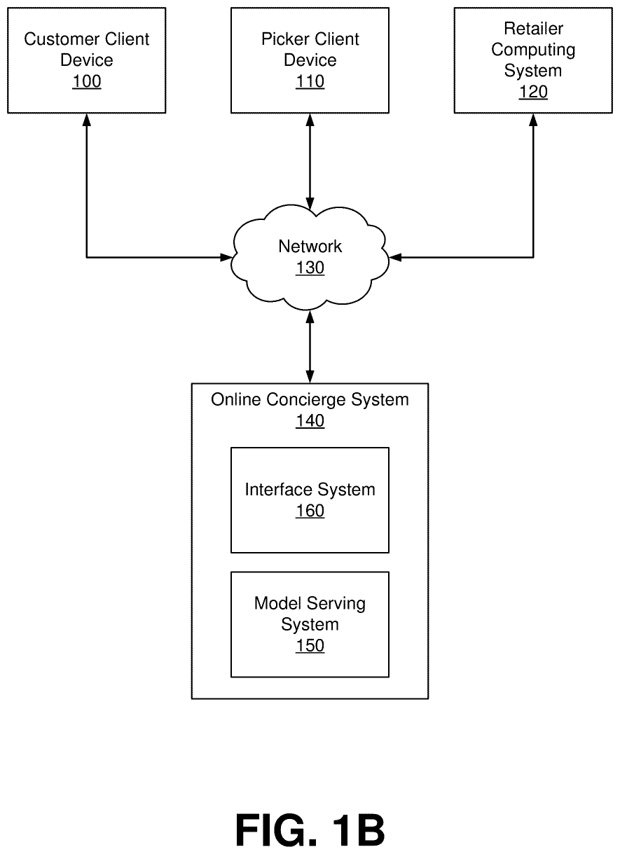

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1A, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item,” as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding, or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

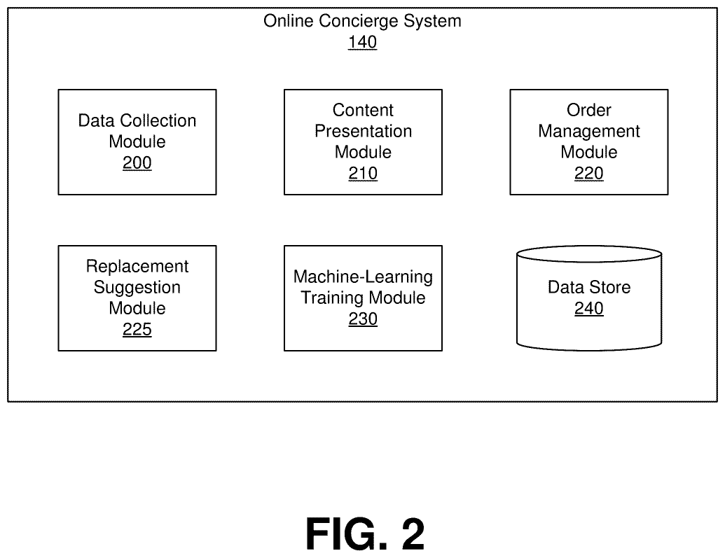

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 determines a list of potential replacement items from an image taken by a user (e.g., a picker). Specifically, the online system 140 prepares a prompt for input to the model serving system 150. The prompt may include an image taken by a picker of an out-of-stock target item. For example, the image may include a tag of the out-of-stock target item. In some embodiments, the image may further include items on nearby shelves. The online system 140 receives a response to the prompt from the model serving system 150 based on execution of the machine-learned model using the prompt. The response may include a list of potential replacement items identified from the image, including for each item a description of the item attributes. The response may also include an identification of the out-of-stock target item and a description of the target item's attributes. In some embodiments, the information from the response is used to determine a ranked list of replacement items using a Replacement Recommendation API.

In one or more embodiments, the multi-modal LLM hosted by the model serving system 150 is coupled to receive input tokens encoding multiple data modalities (e.g., text, image, video, audio) and generate output tokens that can be decoded into an output (e.g., text output). For example, the input tokens may include tokens encoding image pixel data and tokens including text data concatenated together into an input tensor. In one or more embodiments, the multi-modal LLM includes one or more cross-attention layers and/or self-attention layers.

In one or more embodiments, the online system 140 formulates a message with a list of potential replacement items and an explanation for each picker to provide to a user. Specifically, the online system 140 prepares a prompt for input to the model serving system 150. The prompt may include a ranked list of replacement items, including explanations and the rank for each item, as well as a description of what target item is out-of-stock. The online system 140 receives a response to the prompt from the model serving system 150 based on execution of the machine-learned model using the prompt. The online system 140 obtains the response. The response may include a message to the user written to match a provided template. In some embodiments, the information from the response is provided to a Picker API and Picker Customer Chat API, so that the user may select a replacement item.

This disclosure provides a method that utilizes an image of an out-of-stock item as a visual reference for a user to select replacement items. The image may include available items that surround the out-of-stock item. By applying a machine learning model, the method may identify the attributes of the out-of-stock items as well as items that are available in the same category or area. Additionally, the surrounding items may provide contextual information used for generating replacement items, such as, size, color, flavor, and other attributes of the surrounding items.

Moreover, the method generates two sets of potential replacement items, one set based on the image and the other set using one or more replacement models. By combining replacement items suggested by availability and replacement models with those available in the surrounding area, the method provides a wider range of options, which increases the likelihood of finding a suitable replacement. The replacement models may suggest items that are currently in stock, ensuring that replacement items are immediately accessible to the user, which reduces the frustration of selecting a replacement only to find it's also out of stock. Additionally, replacement models may analyze user preferences and historical purchase data to recommend items that closely match the target item in terms of style, features, price range, etc. This personalized approach increases the chances of user satisfaction. By concatenating the two sets of potential replacement items, the method improves the chances of finding a satisfactory replacement item when the target item is out of stock, thus providing an enhanced customer experience.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The replacement suggestion module 225 manages the organization of the list of potential replacement items for a given out-of-stock target item, including the ranking, and structuring of such lists. The replacement suggestion module 225 may receive information from other devices or systems such as a client device of a user (e.g., picker client device 110) or model serving system 150. In some embodiments, the picker client device 110 provides, to the replacement suggestion module 225, an image for use as an image prompt. In some embodiments, the replacement suggestion module 225 may structure a prompt for an LLM based on a predetermined template. For example, a prompt of an image provided by a picker client device 110 with instructions to identify the out-of-stock target item and potential replacement items may include specifications for specific key value pairs as output. As another example, a prompt of a ranked list of potential replacement items may also include instructions to include the list of potential replacement items in a written message based on a given template message.

In some embodiments, the picker client device 110 may further provide, to the replacement suggestion module 225, input signals from the user, for example, text, voice, etc. The picker user (e.g., picker) may include additional instructions/comments in the input signal which may be used to construct the prompt with the image. For example, the user may input a customized request for the customer, e.g., “replacement with organic food only.” The replacement suggestion module 225 may extract key values pairs from the input signal and construct the prompt.

In some embodiments, the output provided by the LLM is provided to other devices or systems, such as the client device of a user (e.g., picker client device 110.) For example, the output of a written message describing a ranked list of potential replacement items may be provided to the picker client device 110 for review or editing, before being sent on further to the customer client device 100. In some embodiments, the output provided by LLM is processed by the replacement suggestion module 225. For example, the output of a list of potential replacement items may be processed by the replacement suggestion module 225, using a replacement recommendation API, to rank and structure the list of potential replacement items, which may be sent back to the LLM as another prompt.

In one or more embodiments, the response from the LLM includes identification of the out-of-stock target item and attributes such as brand, name of item, and the like (e.g., strawberry banana parfait, brand ABC Inc.). The response from the LLM may further include a set of picker-selected replacement items that are, for example, visible in the image taken by the picker, and attributes such as brand, name of replacement item, and the like (e.g., strawberry pineapple parfait, brand APC Inc.). The replacement suggestion module 225 performs a matching process to match the set of picker-selected replacement items in the image to items stored in the product catalog of the online system 140 for the retailer. The replacement suggestion module 225 obtains a first set of replacement items from the picker-selected image.

The replacement suggestion module 225 also obtains a list of model-generated replacement items based on the out-of-stock target item identified from the order of the user and the image. The replacement suggestion module 225 thus obtains a second set of replacement items. Specifically, the second set of replacement items may differ from the first set of replacement items in that the second set of replacement items may not be present in the picker's image, but the replacement suggestion module 225 obtains these replacement item recommendations from one or models stored in the online system 140 for identifying replacement item recommendations. For example, the models may compare similarity measures between a potential replacement item and the out-of-stock target item, may be a machine-learned replacement model trained to generate replacement scores that indicate how suitable a given potential replacement item is for an out-of-stock target item, and the like.

The replacement suggestion module 225 merges the first set of potential replacement items and the second set of replacement items to remove duplicates. The replacement suggestion module 225 determines replacement scores for the replacement items in the merged list and may rank the replacement items according to the replacement scores. In one instance, the replacement suggestion module 225 may prioritize replacement items that were in the first set of picker-selected replacement items visible in the image when ranking the list of replacement items. In some embodiments, the replacement suggestion module 225 may select the replacement items based on the ranking, for example, selecting the top N potential replacement items in the ranking with respect to the replacement scores.

The replacement suggestion module 225 generates a message for a customer based on an item list prompt. The item list prompt includes a structured item list with information about the out-of-stock target item and a list of potential replacement options (e.g., the recommended replacement items), along with the item replacement score for each option on the list, and the source of that replacement item suggestion. The source may indicate, for example, that the replacement item was identified because it was a surrounding item in the photo, or that the replacement item was identified because it is an item deemed to be relevant to the out-of-stock item of the user's order or to the user's order history. The item list prompt may also include instructions to generate the message to match a message template.

The replacement suggestion module 225 provides a list of potential replacement items to the shopper API, displayed on the picker client device 110, for the picker to review and edit if needed. The list of potential replacement items may be in the form of a list of linked item cards, which may include information identifying each item, the corresponding item replacement score, the attributes of the item, etc. The list of potential replacement items may be in the form of a generated message matching a message template. In some embodiments, the replacement suggestion module 225 provides for each item on the list of potential replacement items an explanation of why that potential replacement item is included. The explanation may be limited to predefined categories, such as availability, relevance, and good value. Explanations for a potential replacement item selected by the picker may include a focus on the fact that the potential replacement item is available. Explanations for a potential replacement item generated by a model may include a focus on the value, relevance, and/or similarity of the item as compared to the out-of-stock target item. The picker may then use the Shopper API to push the list of replacement items to the customer for selection of a replacement item.

In some embodiments, replacement suggestion module 225 monitors the actions taken by the picker and the user in order to further train the LLM. In some embodiments, if an image was used as a prompt for input to the LLM, and the LLM failed to read anything, the LLM may need to explain what caused the failure. Some possible reasons for failure to identify items from an image may be the image quality or the label readability. In some embodiments, when the replacement suggestion module 225 receives a response with an explanation indicating a failure, the replacement suggestion module 225 may request from picker client device 110 information for a new prompt as input for the LLM. For example, the picker may choose to take a new image or manually enter the information instead of sending an image to the LLM. In some embodiments, if a picker has chosen to enter information manually and skip sending a prompt to the LLM, the image that failed and the manually information may be used to further train the LLM for future use.

In some embodiments, replacement suggestion module 225 monitors the written message provided to picker client device 110 for editing. If the message is edited to indicate that an item has been mislabeled, mismatched, or otherwise misidentified, the replacement suggestion module 225 tracks such changes for further training of the LLM. An item may be misidentified because an item was falsely labeled as available when it is not, or is labeled as unavailable when it is available. If a picker adds a new item into the message, replacement suggestion module 225 may identify that item, and update the description and records associated with the identified item.

Workflow for Generating Replacement Item Recommendations from Image

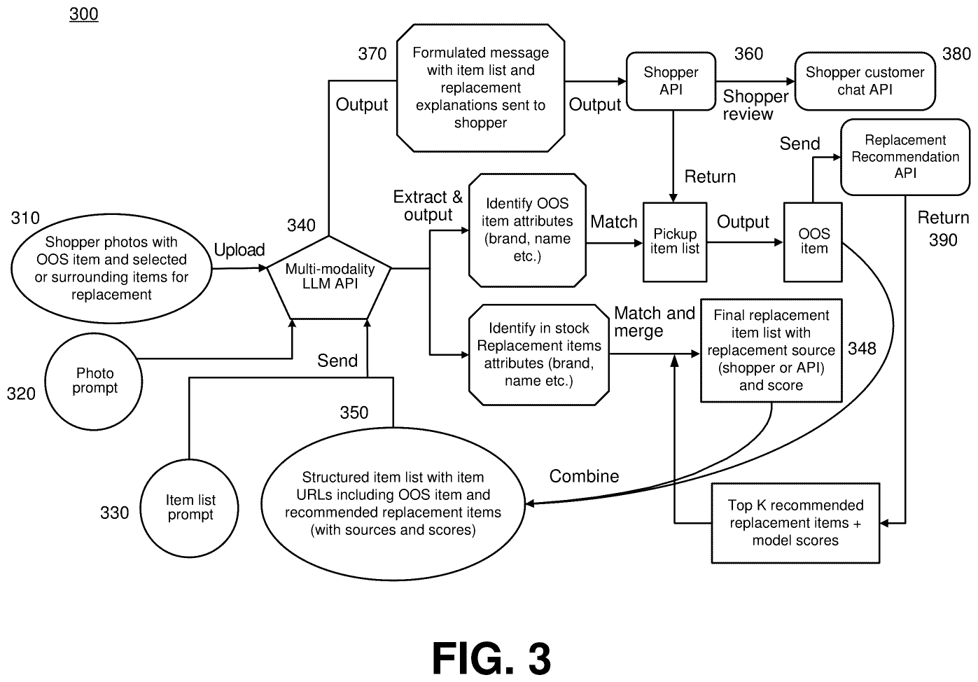

FIG. 3 is a system workflow diagram 300 for identifying replacement item recommendations from an image including an out-of-stock (OOS) item, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives an image 310 indicating that a target item is not available, and that a replacement item needs to be selected. In some embodiments, the online system 140 identifies the target item from the user's order that cannot be found by the picker as an out-of-stock item. The online system 140 may identify the target item as an out-of-stock item based on the image 310 provided by picker client device 110. In some embodiments, the online system 140 may further identify one or more surrounding items, e.g., items surrounding the identified out-of-stock target item in the image 310. In some embodiments, the online system 140 may, upon receiving the image 310 from picker client device 110, and identifying the target item as out of stock, update the predicted availability of that target item in content presentation module 210 and data collection module 200.

The online system 140 uploads the image 310 to a multi-modality LLM API 340 and retrieves, using multi-modality LLM API 340, a list of one or more recommended replacement items. In some embodiments, the online system 140 provides, to the multi-modality LLM API 340, an image prompt 320 with the image 310 provided by picker client device 110. The multi-modality LLM API 340 may be prompted to identify, based on the image 310, specific key value pairs. In some embodiments, the specific value pairs requested from the multi-modality LLM API 340 may include a pair in which the key is the term “OOS” for “Out of Stock” paired with a value of the item information (e.g., SKU) of the target item which is out of stock, as well as a list of potential replacement items.

The response from the multi-modality LLM API 340 includes identification of the out-of-stock item and attributes such as brand, name of item, and the like (e.g., strawberry banana parfait, brand ABC Inc.). The response from the multi-modality LLM API 340 further includes a set of picker-selected replacement items that are, for example, visible in the image 310 taken by the picker, and attributes such as brand, name of replacement item, and the like (e.g., strawberry pineapple parfait, brand APC Inc.). The replacement suggestion module 225 performs a matching process to match the set of picker-selected replacement items in the image 310 to items stored in the product catalog of the online system 140 for the retailer. The replacement suggestion module 225 obtains a first set of replacement items from the picker-selected image 310. In some embodiments, the picker may upload one or more images in addition to the image 310 and instruct the multi-modality LLM API 340 to identify replacement items that are visible in the one or more images for replacing the OOS item in the image 310, based on the out-of-stock item (“OOS item”) identified from the order of the user and the image 310. The replacement suggestion module 225 thus obtains a second set of replacement items. Specifically, the second set of replacement items may differ from the first set of replacement items in that the second set of replacement items may not be present in the picker's image 310, but the replacement suggestion module 225 obtains these replacement item recommendations from one or more models stored in the online system 140 for identifying replacement item recommendations. The model may be exposed via the Replacement Recommendation API 390. For example, multi-modality LLM API 340 may compare similarity measures between a potential replacement item and the out-of-stock item, and may be a machine-learned replacement model trained to generate replacement scores that indicate how suitable a given potential replacement item is for an out-of-stock item, and the like.

The replacement suggestion module 225 merges the first set of potential replacement items and the second set of replacement items to remove duplicates and generate a replacement item list 348. The replacement recommendation API 390 determines replacement scores for the replacement items in the merged list and may rank the replacement items according to the replacement scores. In one instance, replacement recommendation API 390 may prioritize replacement items that were in the first set of picker-selected replacement items visible in the image 310 when ranking the list of replacement items.

In one or more embodiments, from the image 310 of the picker, the online system 140 obtains information about which items are in stock and available in the particular retailer store and which items are out-of-stock (OOS) in the retailer store. The online system 140 can use the information to update the item availability information for the retailer store, such that other users or customers can start making other choices if the desired item is OOS or such that users or customers can be steered towards items that are available. For example, the online system 140 may boost search results for in-stock items.

The online system 140 generates an explanation for a customer based on the image 310. In some embodiments, the online system 140 provides to the multi-modality LLM API 340 an item list prompt 330. An item list prompt 330 may include a structured item list 350 with information about the out-of-stock target item and a list of potential replacement options that were obtained from the replacement item list 348. The item list prompt 330 may also include instructions to generate a message 370 to match a message template.

In some embodiments, the online system 140 provides a list of potential replacement items to the picker for the picker to review 360 and edit if needed. The list of potential replacement items may be in the form of a list of linked item cards, which may include information identifying each item, the corresponding item replacement score. In some embodiments, the online system 140 provides, for each item on the list of potential replacement items, an explanation of why that potential replacement item is included. The explanation may be limited to predefined categories, such as availability, relevance, and good value. The list of potential replacement items may include a combination of potential replacement items selected by the picker, and potential replacement items selected by the replacement recommendation API 390. Explanations for a potential replacement item selected by the picker may include a focus on the fact that the potential replacement item is available. Explanations for a potential replacement item selected by the replacement recommendation API 390 may include a focus on the value, relevance, and/or similarity of the item as compared to the out-of-stock target item.

The online system 140 sends the message to the customer client device 100 and may receive in response a selected replacement item. In some embodiments, the online system 140 will send a message 370, output from the multi-modality LLM API 340, to a Shopper API and Shopper Customer Chat API 380. The message 370 may include a ranked list of potential replacement items including for each item linked item cards/URL links, explanations, and a rank. The message 370 may also include an option to approve or select a replacement, as well as an option to request a refund for the out-of-stock target item.

The online system 140 updates, based on the selected replacement item, an item replacement score for each of the one or more recommended replacement items as associated with the target item by Replacement Recommendation API 390. In some embodiments, the picker may have the opportunity to edit 360 the message before it is sent to customer client device 100 via the Shopper Customer Chat API 380. Any edits made by the picker to the message may be recorded and tracked to further improve and train the multi-modality LLM API 340. In some embodiments, the selection made by customer at the customer client device 100 may be used to update replacement recommendation API 390, as well as the descriptions for the potential replacement items and rankings in the future. For example, if the customer selects an item from the image, that selection may be used to update and train the multi-modality LLM API 340 for future predictions.

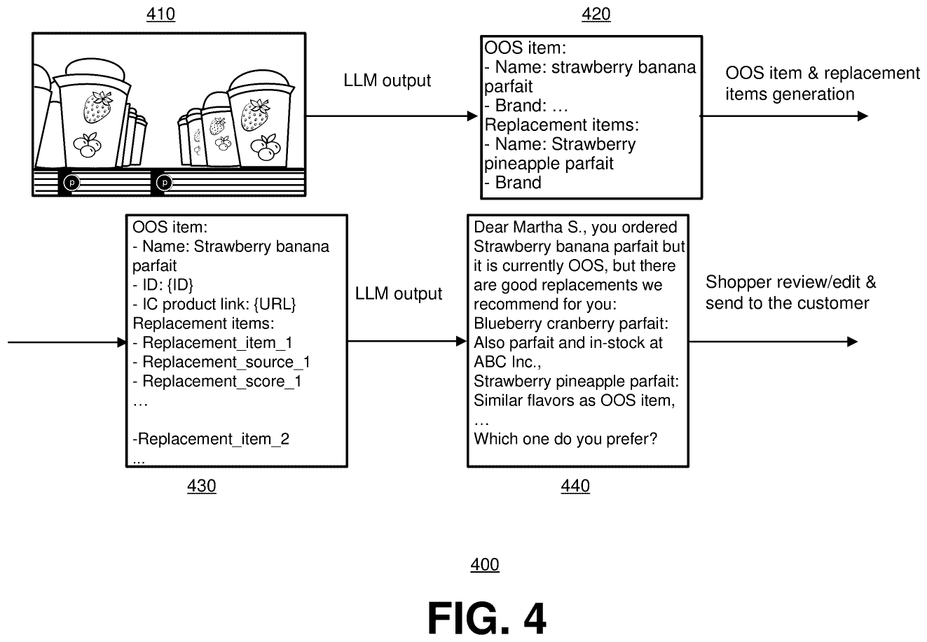

FIG. 4 is a sample process workflow diagram 400 for identifying replacement items for a strawberry banana parfait out-of-stock item, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 provides 410 to a multi-modality LLM API 340 an image prompt 320 including an image 310. The multi-modality LLM API 340 may be prompted to identify, based on the image 310, specific key value pairs to identify an out-of-stock item, and replacement items. In one or more embodiments, the response 420 from the multi-modality LLM API 340 includes identification of the out-of-stock item and attributes such as brand, name of item, and the like (e.g., strawberry banana parfait, brand ABC Inc.). The response 420 from the multi-modality LLM API 340 further includes a set of picker-selected replacement items that are, for example, visible in the image 310 taken by the picker, and attributes such as brand, name of replacement item, and the like (e.g., strawberry pineapple parfait, brand APC Inc.). The replacement suggestion module 225 performs a matching process to match the set of picker-selected replacement items in the image 310 to items stored in the product catalog of the online system 140 for the retailer. The replacement suggestion module 225 obtains a first set of replacement items from the picker-selected image 310.

The replacement suggestion module 225 also obtains a list of model-generated replacement items based on the out-of-stock item identified from the order of the user and the image. The replacement suggestion module 225 thus obtains a second set of replacement items. Specifically, the second set of replacement items may differ from the first set of replacement items in that the second set of replacement items may not be present in the picker's image 310, but the replacement suggestion module 225 obtains these replacement item recommendations from one or models stored in the online system 140 for identifying replacement item recommendations. For example, the models may compare similarity measures between a potential replacement item and the out-of-stock item, may be a machine-learned replacement model trained to generate replacement scores that indicate how suitable a given potential replacement item is for an out-of-stock item, and the like.

The replacement suggestion module 225 merges the first set of potential replacement items and the second set of replacement items to remove duplicates. The replacement suggestion module 225 determines replacement scores for the replacement items in the merged list and may rank the replacement items according to the replacement scores. In one instance, the replacement suggestion module 225 may prioritize replacement items that were in the first set of picker-selected replacement items visible in the image 310 when ranking the list of replacement items. The replacement suggestion module 225 may then rank the remaining items according to their replacement scores.

The replacement suggestion module 225 generates a message for a customer based on an item list prompt 430. The item list prompt 430 includes a structured item list with information about the out-of-stock target item and a list of potential replacement options, along with the item replacement score for each option on the list, and the source of that replacement item suggestion. The item list prompt 430 may also include instructions to generate the message to match a message template.

The replacement suggestion module 225 provides a list of potential replacement items 440 to the Shopper API, displayed on the picker client device 110, for the picker to review and edit if needed. Different from the example shown in FIG. 4, the list of potential replacement items 440 may be in the form of a list of linked item cards, where each card may include information identifying each item, the corresponding item replacement score. The list of potential replacement items 440 may be in the form of a generated message matching a message template. In some embodiments, the replacement suggestion module 225 provides for each item on the list of potential replacement items 440 an explanation of why that potential replacement item is included. The explanation may be limited to predefined categories, such as availability, relevance, and good value. Explanations for a potential replacement item selected by the picker may include a focus on the fact that the potential replacement item is available. Explanations for a potential replacement item generated by a model may include a focus on the value, relevance, and/or similarity of the item as compared to the out-of-stock target item. The picker may then use the Shopper API to push the list of replacement items 440 to the customer for selection of a replacement item. In some implementations, the replacement suggestion module 225 may set a time for receiving a response from the picker, e.g., 5 minute. When the replacement suggestion module 225 does not receive a response from the picker via the Shopper API within the time, the replacement suggestion module 225 may automatically push the list of replacement items and provide the list of replacement items to the customer.

In some embodiments, the replacement suggestion module 225 leverages the image, item list and/or customer selections to update the image prompt and the item list prompt to finetune the LLM. In one example, the image taken by the picker may include unrelated items, and/or items that are not suitable for replacing an out-of-stock target item. For instance, an out-of-stock target item is vinegar, and the surrounding items, that are visible in the image, may include, soy sauce, barbeque sauce, etc., which are not suitable for replacing vinegar. In some implementations, the replacement suggestion module 225 may concatenate image data and the replacement items in the item list. The image data may include known instances of images of a known out-of-stock item with known brand and attributes. The replacement items in the item list include items with known brands and attributes. By inputting the corresponding image prompt and the item list prompt in the LLM, the replacement suggestion module 225 may evaluate the accuracy of the identification of the out-of-stock target item and the potential replacement items generated by the LLM. In one example, the replacement suggestion module 225 may set a finetuning objective for training the LLM and a loss function may be applied to compare the difference between the LLM generated replacement items and the known replacement items. The loss may be associated with a value indicating a level of the difference, for example, how likely the customer may select the replacement item, and how similar the replacement item is to the out-of-stock target item. In the next iteration, the replacement suggestion module 225 can adjust the differences from the original LLM using reinforcement learning. The parameters of the replacement suggestion module 225 may be updated by backpropagating through the LLM based on the loss.

In one implementation, the replacement suggestion module 225 may finetune the LLM using a plurality of training examples. Each training example may include a training image that includes an out-of-stock item having known identification and a set of items adjacent to the out-of-stock item with known attributes. The replacement suggestion module 225 may apply the LLM to the training image and receive a response from the LLM. The response may include an identification of the out-of-stock item in the training image and a set of replacement items based on the training image. In some embodiments, the replacement suggestion module 225 may evaluate the response by calculating a loss. For example, the replacement suggestion module 225 may calculate a first loss indicating a difference between the generated identification and known identification of the out-of-stock item and a second loss indicating a difference between the set of replacement items and the set of items adjacent to the out-of-stock item with known attributes. The replacement suggestion module 225 may generate a loss function combining the first loss and the second loss to evaluate the response output from the LLM. The replacement module 225 finetunes the LLM by backpropagating the LLM to update parameters of the LLM obtained from the computed loss from the loss function. In this way, the replacement suggestion module 225 finetunes the LLM to output a more accurate identification of the out-of-stock item and a list of more accurate replacement items.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the sets of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data. The data store 240 may store a plurality of message templates used for generating a message for a customer based on an item list prompt. In some embodiments, the message templates may define the content, formats, items, etc., included in a message. In some embodiments, a message template may be associated with metadata that describes the information of the message temple, for example, indicating that the message template presents each replacement item in an interactable/selectable user interface element.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

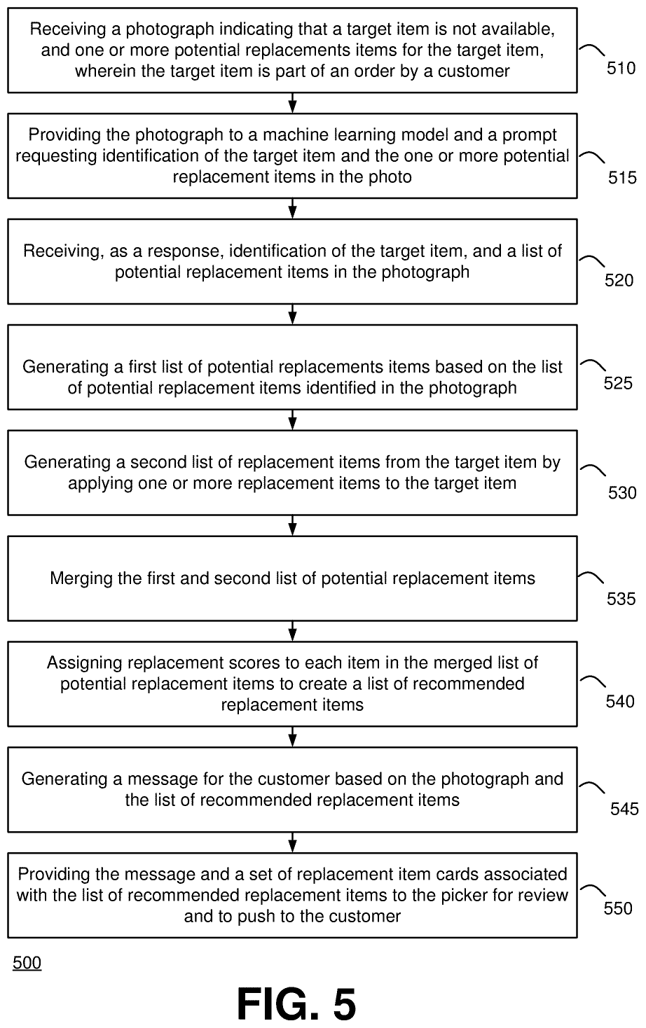

FIG. 5 is a flowchart 500 for determining target item replacements, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

In one or more embodiments, the online system 140 receives 510 an image 310, from a user (e.g., a picker), at picker client device 110. The image 310 may indicate that a target item is not available, and the target item is part of an order by a customer. In some embodiments, the image 310 may further indicate one or more potential replacements items for the target item. The online system 140 provides 515 to a machine learning model, such as multi-modality LLM API 340, the image 310 as well as a prompt requesting identification of the target item and the one or more potential replacement items in the image 310. The online system 140 receives 520, as a response, identification of the target item, and a list of potential replacement items in the image 310. The online system 140 generates 525 a first list of potential replacement items based on the list of potential replacement items identified in the image. The online system 140 generates 530 a second list of replacement items from the target item by applying one or more replacement items to the target item. The online system 140 merges 535 the first and second list of potential replacement items. The online system 140 assigns 540 replacement scores to each item in the merged list of potential replacement items to create a list of recommended replacement items. The online system 140 generates 545 a message for the customer based on the image 310 and the list of recommended replacement items. The online system 140 provides 550 the message and a set of replacement item cards associated with the list of recommended replacement items to the picker, at picker client device 110, for review and to push to the customer, at customer client device 100. In some embodiments, the online system 140 receives from the customer, at customer client device 100, a selected replacement item. The online system 140 updates, based on the selected replacement item, an item replacement score for each of the one or more recommended replacement items as associated with the target item.

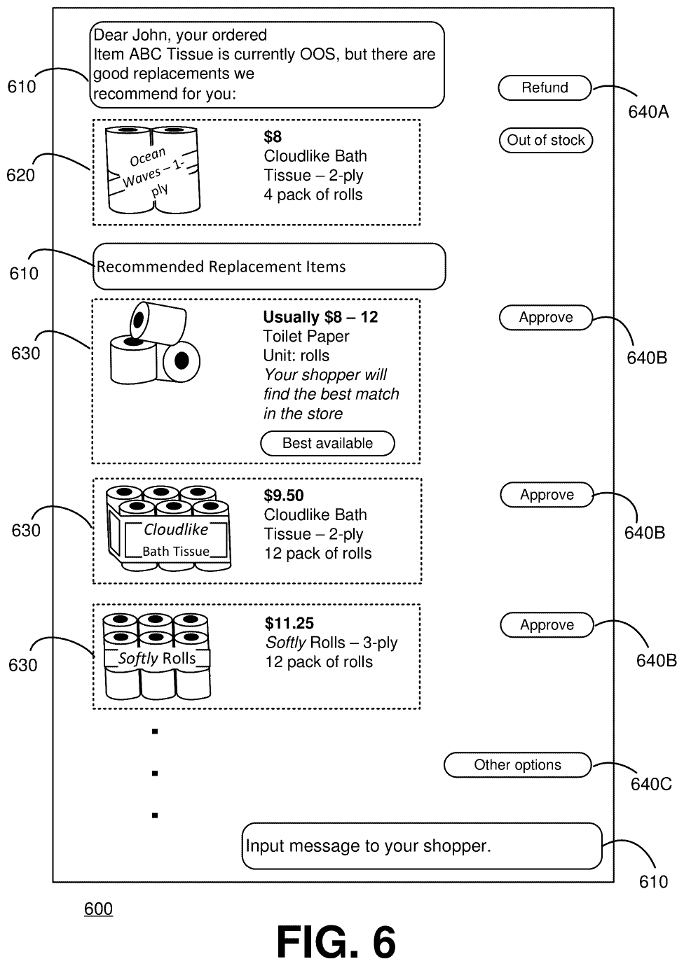

FIG. 6 is an example of a user interface 600 depicting a message, received by a user of an order, for recommending replacement items for an out-of-stock target item, according to some embodiments. Alternative embodiments may include more, fewer, or different components/configurations from those illustrated in FIG. 6, and the functionality of each component may be divided between the components differently from the description below. Additionally, each component may perform their respective functionalities in response to a request from a human, or automatically without human intervention.

A user may interact with the user interface 600 to select a replacement item. Specifically, the examiner user interface 600 may be generated responsive to a picker pushing the message using the shopper customer chat API to the user. The user interface 600 displays interactive elements that the user interacts with to select a replacement item. As shown in FIG. 6, the user interface 600 may include communicative user interface elements, e.g., 610, which are used for communications between the user and the picker/the online system 140. For example, the communicative user interface elements 610 may include information explaining that a certain item is out of stock, and suggesting the user selecting a replacement item or request a refund, etc. The communicative user interface elements 610 may also allow the user to input messages to the shopper, provide feedback, questions, request, etc. The user interface 600 may present the out-of-stock item in an interactable item card 620. The user may interact (e.g., click, tap, etc.) the item card 620 to access additional information of the out-of-stock target item. The user interface 600 may also present each replacement item in an interactable item card 630. Each interactable item card 630 may include for each item, information (such as brand, attributes, etc.), URL links, explanations. In some embodiments, the interactable item card 630 may further include promotion messages, such as “best available,” “price cut,” etc. In some implementations, the user may interact with the interactable item card 630 to access additional information and/or the links. The user interface 600 may further include a set of interactive user interface elements, e.g., 640A, 640B, 640C, for the user to select, approve replacement or request a refund. In some implementations, the set of interactive user interface elements may include an interface element 640C that allows the user to select replacement items that are not included in the message. The user may interact with the interactive user interface element 640C, e.g., “other options,” and access to the catalog of all items that are available to the customer, which the customer can browse to select items for replacement. In some implementations, the online system 140 may cause the user interface 600 to re-arrange the positions of the user interface elements based on the customer's usage history/pattern/preference. For example, when identifying that a user frequently selects “refund” option when an item is out of stock, the online system 140 may cause the user interface 600 to position the user interface element 640A, “Refund,” at a more prominent location, e.g., top of the user interface 600. In another example, when identifying that a customer frequently selects the user interface element 640C, “other options,” the online system 140 may cause the user interface 600 to modify the position of the interface element 640C and move it to a more prominent location, e.g., top of the user interface 600.

In some implementations, before the user is presented with the user interface 600, the replacement message may be presented to the picker/shopper in a user interface that is similar to the user interface 600. The user interface may be displayed on the picker client device 110, for the picker to review and edit if needed. Similarly, the list of potential replacement items may be presented in interactive user interface elements. When interacted, the user interface element may display information identifying each item, the corresponding item replacement score, the attributes of the item, explanation of why that potential replacement item is included, etc. The user interface may also allow the picker to re-arrange the user interface element corresponding to each replacement item, for example, moving the position of the user interface element up or down in the user interface so that the corresponding replacement item may be presented a more prominent position in the customer's user interface and more convenient for the customer to view and select (e.g., re-arranged according to replacement scores for each item). In some implementations, the online system 140 may allow the picker to add or remove a replacement item from the user interface.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present), and B is false (or not present), A is false (or not present), and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present), and C is false (or not present). Similarly, as another not-limiting example, the condition “A, B, or C” is satisfied when A is true (or present), and B and C are false (or not present).

What is claimed is:

1. A method comprising:
receiving an image, from a user, indicating that a target item is not available, and the image comprising one or more potential replacements items for the target item;
providing, to a machine learning model, the image and a prompt requesting identification of the target item and the one or more potential replacement items in the image;
receiving, as a response, identification of the target item, and the one or more potential replacement items identified in the image;
generating a first list of potential replacements items based on the one or more potential replacement items identified in the image;
generating a second list of potential replacement items from the target item by applying one or more replacement models to the identified target item;
merging the first list and the second list of potential replacement items;
assigning replacement scores to each item in the merged list of potential replacement items to create a list of recommended replacement items;
generating a message based on the image and the list of recommended replacement items; and
providing the message and a set of replacement item cards associated with the list of recommended replacement items to the user for review.

2. The method of claim 1, further comprising:
updating availability information to indicate that identified target item is not available at a location and the list of potential replacement items is available at the location; and
providing, to a second user, an indication that the target item is not available at the location and a recommendation to obtain a potential replacement item in the list to the second user.

3. The method of claim 1, further comprising finetuning the machine learning model to generate an updated machine learning model, the finetuning comprising:
applying the machine learning model to a training image, the training image comprising an out-of-stock item having known identification and a set of items adjacent to the out-of-stock item with known attributes;
receiving, from the machine learning model, a response comprising an identification of the out-of-stock item in the training image and a set of replacement items based on the training image;
generating a loss function combining a first loss indicating a difference between the generated identification and known identification of the out-of-stock item and a second loss indicating a difference between the set of replacement items and the set of items adjacent to the out-of-stock item with known attributes; and
backpropagating the machine learning model to update parameters of the machine learning model obtained from computed loss from the loss function.

4. The method of claim 1, wherein the message includes an explanation for each of the list of recommended replacement items.

5. The method of claim 1, further comprising:
pushing, via a user interface, the message to a customer user; and
presenting each of the list of recommended replacement items in an interactable user interface element that allows the customer to select the respective recommended replacement item for replacing the target item.

6. The method of claim 1, wherein generating the message comprises:
generating a prompt for input to a machine-learned language model, the prompt includes the list of recommended replacement items and an instruction to include the list of recommended replacement items in a written message based on a given message template; and
receiving, from the machine-learned language model, a response comparing the generated message.

7. The method of claim 1, further comprising:
automatically pushing, via a user interface, the message to a customer user.

8. A computer program product comprising a non-transitory computer readable storage medium having instructions encoded thereon that, when executed by a processor, cause the processor to perform steps comprising:
receiving an image, from a user, indicating that a target item is not available, and the image comprising one or more potential replacements items for the target item;
providing, to a machine learning model, the image and a prompt requesting identification of the target item and the one or more potential replacement items in the image;
receiving, as a response, identification of the target item, and the one or more potential replacement items identified in the image;
generating a first list of potential replacements items based on the one or more potential replacement items identified in the image;
generating a second list of potential replacement items from the target item by applying one or more replacement models to the identified target item;
merging the first list and the second list of potential replacement items;
assigning replacement scores to each item in the merged list of potential replacement items to create a list of recommended replacement items;
generating a message based on the image and the list of recommended replacement items; and
providing the message and a set of replacement item cards associated with the list of recommended replacement items to the user for review.

9. The computer program product of claim 8, wherein the instructions encoded thereon that, when executed by a processor, cause the processor to perform steps comprising:
updating availability information to indicate that identified target item is not available at a location and the list of potential replacement items is available at the location; and
providing, to a second user, an indication that the target item is not available at the location and a recommendation to obtain a potential replacement item in the list to the second user.

10. The computer program product of claim 8, wherein the instructions encoded thereon that, when executed by a processor, cause the processor to perform steps comprising:
finetuning the machine learning model to generate an updated machine learning model, the finetuning comprising:
applying the machine learning model to a training image, the training image comprising an out-of-stock item having known identification and a set of items adjacent to the out-of-stock item with known attributes;
receiving, from the machine learning model, a response comprising an identification of the out-of-stock item in the training image and a set of replacement items based on the training image;
generating a loss function combining a first loss indicating a difference between the generated identification and known identification of the out-of-stock item and a second loss indicating a difference between the set of replacement items and the set of items adjacent to the out-of-stock item with known attributes; and
backpropagating the machine learning model to update parameters of the machine learning model obtained from computed loss from the loss function.

11. The computer program product of claim 8, wherein the message includes an explanation for each of the list of recommended replacement items.

12. The computer program product of claim 8, wherein the instructions encoded thereon that, when executed by a processor, cause the processor to perform steps comprising:
pushing, via a user interface, the message to a customer; and
presenting each of the list of recommended replacement items in an interactable user interface element that allows the customer to select the respective recommended replacement item for replacing the target item.

13. The computer program product of claim 8, wherein the instructions to generate the message encoded thereon that, when executed by a processor, cause the processor to perform steps comprising:
generating a prompt for input to a machine-learned language model, the prompt includes the list of recommended replacement items and an instruction to include the list of recommended replacement items in a written message based on a given message template; and
receiving, from the machine-learned language model, a response comparing the generated message.

14. The computer program product of claim 8, wherein the instructions encoded thereon that, when executed by a processor, cause the processor to perform steps comprising:
automatically pushing, via a user interface, the message to a customer user.

15. A computer system comprising:
a processor; and
a non-transitory computer-readable storage medium having instructions that, when executed by the processor, cause the computer system to perform steps comprising:
receiving an image, from a user, indicating that a target item is not available, and the image comprising one or more potential replacements items for the target item;
providing, to a machine learning model, the image and a prompt requesting identification of the target item and the one or more potential replacement items in the image;
receiving, as a response, identification of the target item, and the one or more potential replacement items identified in the image;
generating a first list of potential replacements items based on the one or more potential replacement items identified in the image;
generating a second list of potential replacement items from the target item by applying one or more replacement models to the identified target item;
merging the first list and the second list of potential replacement items;
assigning replacement scores to each item in the merged list of potential replacement items to create a list of recommended replacement items;
generating a message based on the image and the list of recommended replacement items; and
providing the message and a set of replacement item cards associated with the list of recommended replacement items to the user for review.

16. The computer system of claim 15, wherein the instructions, when executed by the processor, cause the computer system to perform steps comprising:
updating availability information to indicate that identified target item is not available at a location and the list of potential replacement items is available at the location; and
providing, to a second user, an indication that the target item is not available at the location and a recommendation to obtain a potential replacement item in the list to the second user.

17. The computer system of claim 15, wherein the instructions, when executed by the processor, cause the computer system to perform steps comprising:
finetuning the machine learning model to generate an updated machine learning model, the finetuning comprising:
applying the machine learning model to a training image, the training image comprising an out-of-stock item having known identification and a set of items adjacent to the out-of-stock item with known attributes;
receiving, from the machine learning model, a response comprising an identification of the out-of-stock item in the training image and a set of replacement items based on the training image;
generating a loss function combining a first loss indicating a difference between the generated identification and known identification of the out-of-stock item and a second loss indicating a difference between the set of replacement items and the set of items adjacent to the out-of-stock item with known attributes; and
backpropagating the machine learning model to update parameters of the machine learning model obtained from computed loss from the loss function.

18. The computer system of claim 15, wherein the instructions, when executed by the processor, cause the computer system to perform steps comprising:
automatically pushing, via a user interface, the message to a customer

19. The computer system of claim 15, wherein the instructions, when executed by the processor, cause the computer system to perform steps comprising:
pushing, via a user interface, the message to a customer; and
presenting each of the list of recommended replacement items in an interactable user interface element that allows the customer to select the respective recommended replacement item for replacing the target item.

20. The computer system of claim 15, wherein the instructions to generate the message, when executed by the processor, cause the computer system to perform steps comprising:
generating a prompt for input to a machine-learned language model, the prompt includes the list of recommended replacement items and an instruction to include the list of recommended replacement items in a written message based on a given message template; and
receiving, from the machine-learned language model, a response comparing the generated message.
